(19) United States
(12) Patent Application Publication
(10) Pub. No.: US 2017/0014284 A1
(43) Pub. Date: Jan. 19, 2017

(54) Cart System

(71) Applicant: Paul Chandler, Attapugus, GA (US)

(72) Inventor: Paul Chandler, Attapugus, GA (US)

(21) Appl. No.: 14/802,535

(22) Filed: Jul. 17, 2015

(51) Int. Cl. A61G 1/013; A61G 1/02

(52) U.S. Cl. CPC A61G 1/013; A61G 1/0237

(57) ABSTRACT

A cart system includes a stretcher that may be rolled outwardly from a vehicle. The stretcher has a frame and a plurality of legs movably coupled to the frame. Each of the plurality of legs is positionable in a deployed position and a stored position. A plurality of first wheels is provided and each of the first wheels is rotatably coupled to one of the plurality of legs. Thus, each of the first wheels may roll along a support surface. A pair of struts is provided and each of the struts is coupled to the stretcher. Each of the struts is positioned on the frame such that each of the struts may rollably engage the support surface when the plurality of legs is positioned in the stored position. Thus, the frame is inhibited from frictionally engaging the support surface.

### BACKGROUND OF THE DISCLOSURE

### Field of the Disclosure

The disclosure relates to cart devices and more particularly pertains to a new cart device for being rollable inwardly and outwardly from a vehicle.

### SUMMARY OF THE DISCLOSURE

An embodiment of the disclosure meets the needs presented above by generally comprising a stretcher that may be rolled outwardly from a vehicle. The stretcher has a frame and a plurality of legs movably coupled to the frame. Each of the plurality of legs is positionable in a deployed position and a stored position. A plurality of first wheels is provided and each of the first wheels is rotatably coupled to one of the plurality of legs. Thus, each of the first wheels may roll along a support surface. A pair of struts is provided and each of the struts is coupled to the stretcher. Each of the struts is positioned on the frame such that each of the struts may rollably engage the support surface when the plurality of legs is positioned in the stored position. Thus, the frame is inhibited from frictionally engaging the support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a cart system according to an embodiment of the disclosure.

FIG. 2 is a perspective view of an embodiment of the disclosure.

FIG. 3 is a right side view of an embodiment of the disclosure in a deployed position.

FIG. 4 is a right side view of an embodiment of the disclosure in a stored position.

FIG. 5 is a back view of an embodiment of the disclosure.

### DESCRIPTION OF THE PREFERRED EMBODIMENT

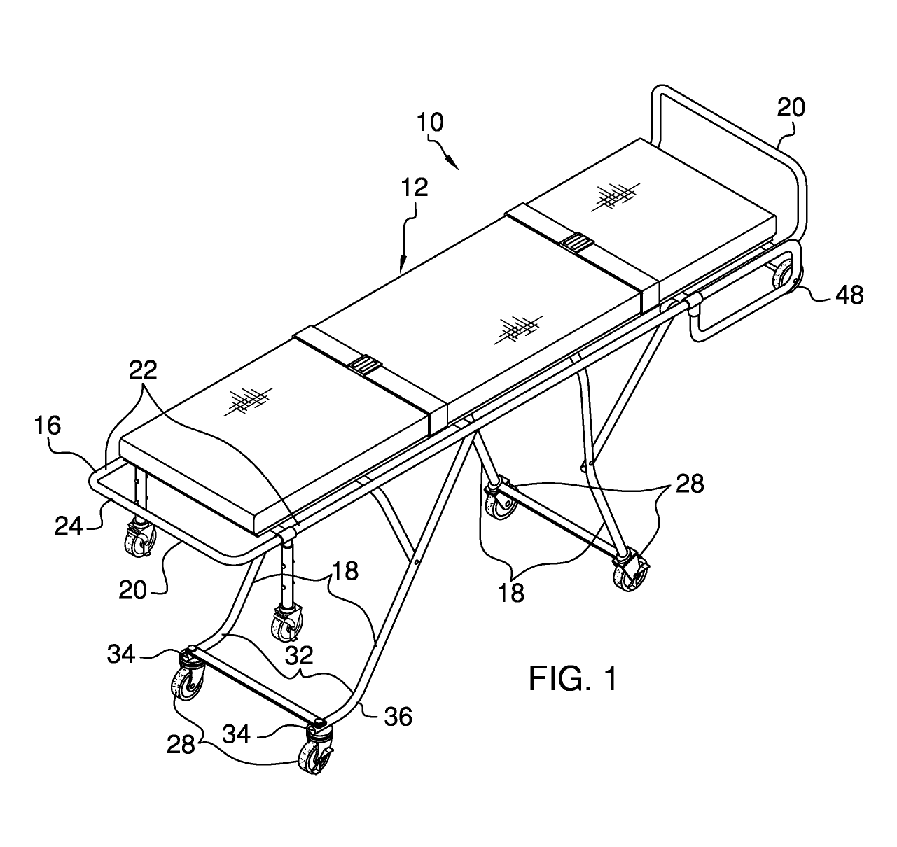

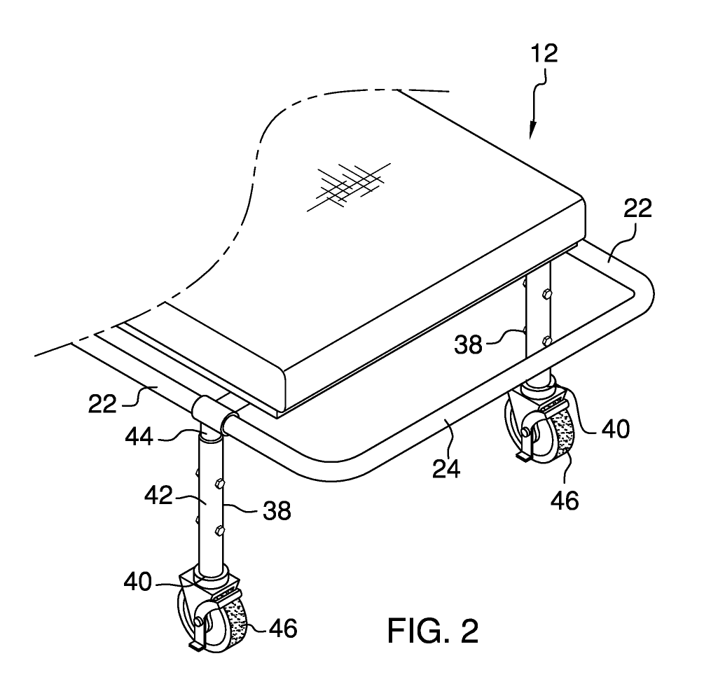

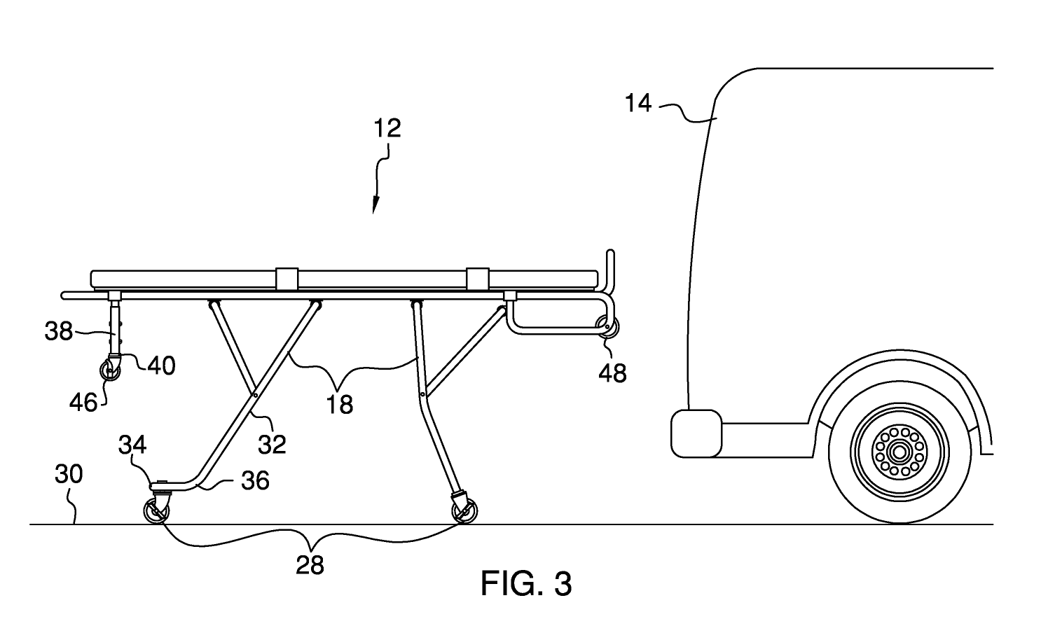

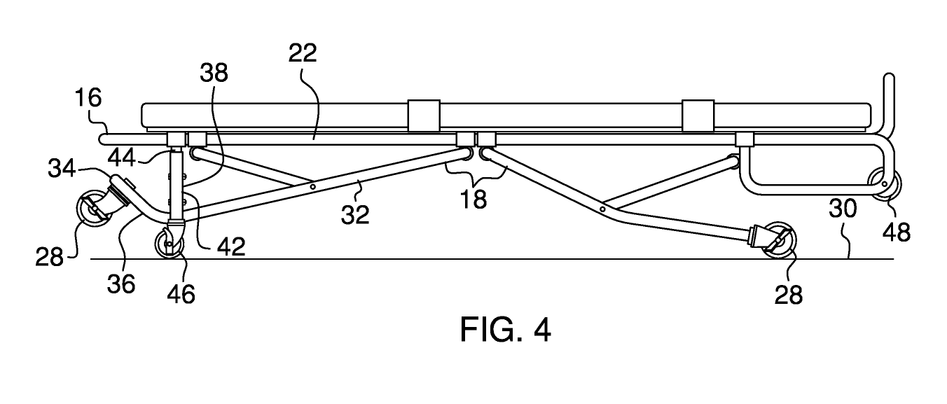

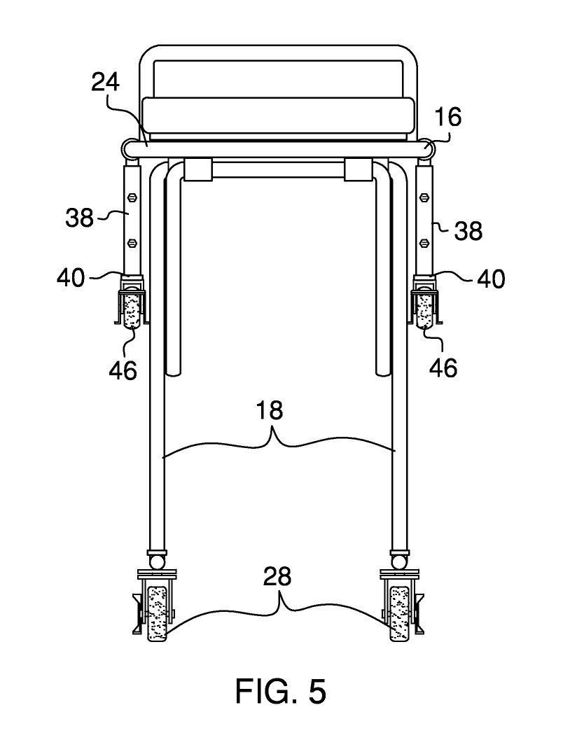

With reference now to the drawings, and in particular to FIGS. 1 through 6 thereof, a new cart device embodying the principles and concepts of an embodiment of the disclosure and generally designated by the reference numeral 10 will be described.

As best illustrated in FIGS. 1 through 6, the cart system 10 generally comprises a stretcher 12 that may be rolled outwardly from a vehicle 14. The vehicle 14 may be a hearse or the like. The stretcher 12 has a frame 16 and a plurality of legs 18 movably coupled to the frame 16. The frame 16 includes a pair of lateral arms 20 and a pair of longitudinal arms 22. Each of the lateral arms 20 is coupled to and extends between each of the longitudinal arms 22 and the pair of lateral arms 20 includes a rear one 24 of the lateral arms 20. Each of the plurlaity of legs 18 is positionable in a deployed position having each of the plurlaity of legs 18 extending downwardly from the frame 16. Each of the plurlaity of legs 18 is positionable in a stored position having each of the plurlaity of legs 18 being coextensive with the frame 16.

A plurality of first wheels 28 is provided and each of the first wheels 28 is rotatably coupled to one of the legs 26. Each of the first wheels 28 may roll along a support surface 30. The plurlaity of legs 18 includes a first set of legs 32 and each of the first set of legs 32 is positioned proximate the rear lateral arm 24. Each of the first set of legs 32 has a distal end 34 with respect to the frame 16. Each of the first set of legs 32 has a bend 36 thereon and the bend 36 is positioned proximate the distal end 34 of an associated one of the first set of legs 32. The distal end 34 of each of the first set of legs 32 is directed upwardly from the support surface 30 when the first set of legs 32 is positioned in the stored position. Thus, the bend 36 is positioned to frictionally the support surface 30 when the first set of legs 32 is in the stored position.

A pair of struts 38 is provided and each of the struts 38 is coupled to the stretcher 12. Each of the struts 38 is positioned on the frame 16 such that each of the struts 38 may rollably engage the support surface 30 when the plurlaity of legs 18 is positioned in the stored position. Thus, the struts 38 inhibit the frame 16 from frictionally engaging the support surface 30. Additionally, the bend 36 on each of the first set of legs 32 is spaced from the support surface 30 when the first set of legs 32 is positioned in the stored position.

Each of the pair of struts 38 is positioned on an associated one of the longitudinal arms 22. Each of the pair of struts 38 is positioned adjacent to the rear lateral arm 24. Each of the struts 38 has a distal end 40 with respect to the frame 16. Each of the struts 38 has a first portion 42 that is slidably coupled to a second portion 44 such that each of the struts 38 has a telescopically adjustable length.

A pair of second wheels 46 is provided and each of the second wheels 46 is rotatably coupled to an associated one of the struts 38. Each of the second wheels 46 is positioned on the distal end 40 of the associated strut 38. Thus, each of the second wheels 46 may roll along the support surface 30 when each of the plurlaity of legs 18 is positioned in the stored position. Each of the second wheels 46 is spaced from the support surface 30 when each of the plurlaity of legs 18 is positioned in the deployed position.

The stretcher 12 additionally includes a pair of rollers 48 that are each coupled to the frame 16. Each of the rollers 48 is coupled to an associated one of the longitudinal arms 22. Each of the rollers 48 is spaced from the struts 38. Each of the rollers 48 engages the support surface 30 when the legs 26 are positioned in the stored position. Thus, the stretcher 12 rolls on the second wheels 46 and the rollers 48 when the legs 26 are positioned in the stored position.

In use, the legs 26 are positioned in the stored position when the stretcher 12 is positioned within the vehicle 14. The struts 38 keep the first set of legs 32 from frictionally engaging the vehicle 14 when the first set of legs 32 is in the stored position. Thus, the struts 38 facilitate the stretcher 12 to be removed from the vehicle 14. Additionally, the struts 38 keep the frame 16 spaced from the vehicle 14 when the legs 26 are in the stored position. The first set of legs 32 may be manipulated without having to lift the frame 16 upwardly from the vehicle 14 to access the first set of legs 32. Thus, the struts 38 reduce the chances of lower back injury resulting from lifting the frame 16.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cart system comprising:
a stretcher being configured to be rolled outwardly from a vehicle, said stretcher having a frame and a plurality of legs movably coupled to said frame, each of said plurality of legs being positionable in a deployed position and a stored position;
a plurality of first wheels, each of said first wheels being rotatably coupled to an associated one of said plurality of legs wherein each of said first wheels is configured to roll along a support surface; and
a pair of struts, each of said struts being coupled to said stretcher, each of said struts being positioned on said frame wherein each of said struts is configured to rollably engage the support surface when said plurality of legs is positioned in said stored position thereby inhibiting said frame from frictionally engaging the support surface.

2. The system according to claim 1, wherein said frame includes a pair of lateral arms and a pair of longitudinal arms, each of said lateral arms being coupled to and extending between each of said longitudinal arms, said pair of lateral arms including a rear one of said lateral arms.

3. The system according to claim 2, wherein each of said pair of struts is positioned on an associated one of said longitudinal arms, each of said pair of struts being positioned adjacent to said rear lateral member, each of said struts having a distal end with respect to said frame.

4. The system according to claim 1, wherein each of said struts has a first portion being slidably coupled to a second portion such that each of said struts has a telescopically adjustable length.

5. The system according to claim 1, wherein:
each of said struts has a distal end with respect to said frame; and
a pair of second wheels, each of said second wheels being rotatably coupled to an associated one of said struts, each of said second wheels being positioned on a distal end of said associated strut wherein each of said second wheels is configured to roll along the support surface when each of said plurality of legs is positioned in said stored position, each of said second wheels being spaced from the support surface when each of said plurality of legs is positioned in said deployed position.

6. A cart system comprising:
a stretcher being configured to be rolled outwardly from a vehicle, said stretcher having a frame and a plurality of legs movably coupled to said frame, said frame including a pair of lateral arms and a pair of longitudinal arms, each of said lateral arms being coupled to and extending between each of said longitudinal arms, said pair of lateral arms including a rear one of said lateral arms, each of said plurality of legs being positionable in a deployed position having each of said plurality of legs extending downwardly from said frame, each of said plurality of legs being positionable in a stored position having each of said plurality of legs being coextensive with said frame;
a plurality of first wheels, each of said first wheels being rotatably coupled to an associated one of said plurality of legs wherein each of said first wheels is configured to roll along a support surface;
a pair of struts, each of said struts being coupled to said stretcher, each of said struts being positioned on said frame wherein each of said struts is configured to rollably engage the support surface when said plurality of legs is positioned in said stored position thereby inhibiting said frame from frictionally engaging the support surface, each of said pair of struts being positioned on an associated one of said longitudinal arms, each of said pair of struts being positioned adjacent to said rear lateral member, each of said struts having a distal end with respect to said frame, each of said struts having a first portion being slidably coupled to a second portion such that each of said struts has a telescopically adjustable length; and
a pair of second wheels, each of said second wheels being rotatably coupled to an associated one of said struts, each of said second wheels being positioned on said distal end of said associated strut wherein each of said second wheels is configured to roll along the support surface when each of said plurality of legs is positioned in said stored position, each of said second wheels being spaced from the support surface when each of said plurality of legs is positioned in said deployed position.
